(19) United States
(12) Patent Application Publication
(10) Pub. No.: US 2016/0151891 A1
(43) Pub. Date: Jun. 2, 2016

(54) FLATNESS ADJUSTING DEVICE AND TEST FIXTURE APPLYING THE FLATNESS ADJUSTING DEVICE

(71) Applicants: Fu Tai Hua Industry (Shenzhen) Co., Ltd., Shenzhan (CN); HON HAI PRECISION INDUSTRY CO., LTD., New Taipei (TW)

(72) Inventor: JU-LAN HAO, Shenzhen (CN)

(21) Appl. No.: 14/590,189

(22) Filed: Jan. 6, 2015

(30) Foreign Application Priority Data
Nov. 27, 2014 (CN) 201410695595.7

(51) Int. Cl. B25B 5/14; B23Q 3/06

(52) U.S. Cl. CPC B25B 5/145; B23Q 3/062

(57) ABSTRACT

A test fixture includes a flatness adjusting device and a test module. The flatness adjusting device includes a holding module. The flatness adjusting device is configured for leveling a work-piece held in the holding module. The flatness adjusting device also includes elastic members and limit members. Bottom surfaces of the limit members are in a horizontal plane. The elastic members are placed on the holding module. The work-piece is located between the elastic members and the limit members and a top surface of the work-piece is attached on the bottom surfaces of the limit members closely.

### FIELD

The disclosure relates to an assistant module, and particularly relates to a flatness adjusting device and a test fixture applying the flatness adjusting device.

### BACKGROUND

A work-piece is always held in a holding module to satisfy matching to complex operation requirement. A datum plane of the holding module is usually used for orientating the work-piece held therein.

### BRIEF DESCRIPTION OF THE DRAWINGS

Implementations of the present technology will now be described, by way of example only, with reference to the attached figures.

FIG. 1 is an isometric, assembled view of a test fixture applying a flatness adjusting device in accordance with an exemplary embodiment of the present disclosure.

FIG. 2 is an exploded, isometric view of the test fixture in FIG. 1.

FIG. 3 is an isometric, assembled view of the test fixture in a test operating state in FIG. 1.

FIG. 4 is a cross-sectional view of a portion of the device in FIG. 3, taken along a line IV-IV thereof.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and members have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The flatness adjusting device 100 of the present disclosure can be applied in test fixtures, automatic assembly lines and so on. In this embodiment, an application of the flatness adjusting device 100 in a test fixture 300 is introduced. The flatness adjusting device 100 is configured for adjusting a datum plane of a work-piece 200 held in the test fixture 300. So that the work-piece 200 can be adjusted in a horizontal position and be tested in a correct contraposition. What should be particularly explained is that the work-piece 200 is planar.

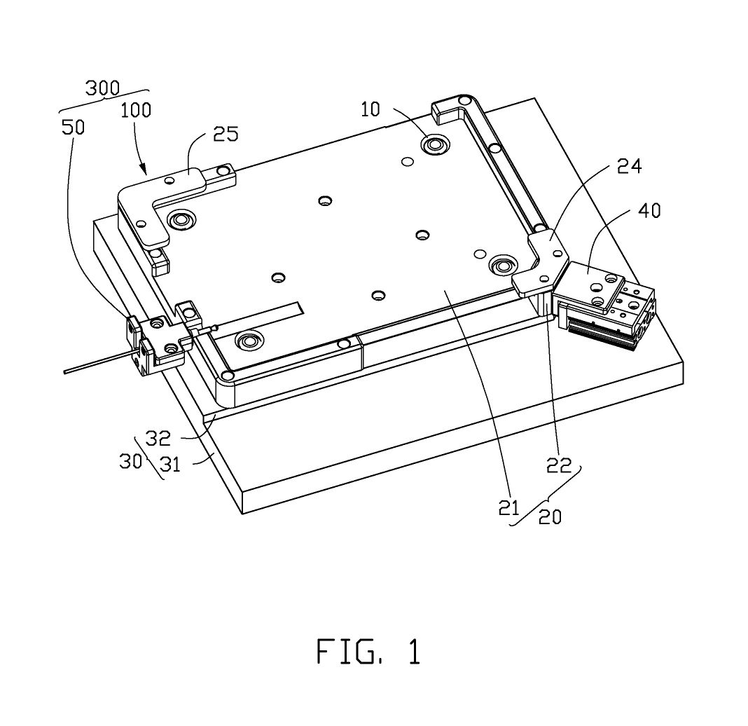

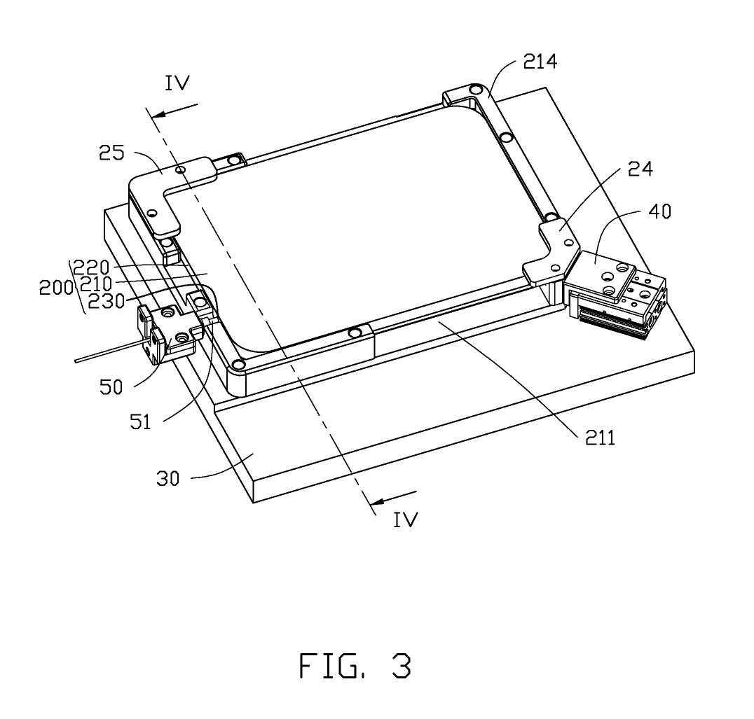

Referring to FIG. 1, the flatness adjusting device 100 includes elastic members 10, a holding module 20 for holding the work-piece 200 (as shown in FIG. 3), limit members, and a faceplate 30 for carrying the holding module 20.

The elastic members 10 are placed on the holding module 20. Each elastic member 10 is an elastomer, such as rubber, a spring and so on. In this embodiment, the elastic members 10 include at least three elastic ball plungers. The elastic ball plungers are spaced from each other to form a geometric figure which is a non linear graph, such as a triangle, a quadrangle and so on.

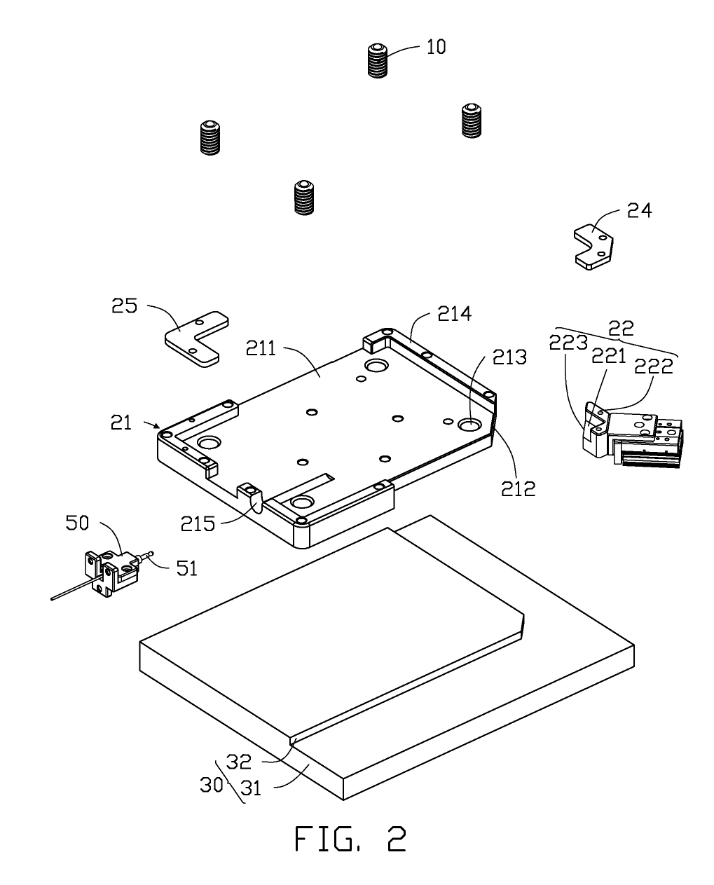

Referring to FIG. 1 and FIG. 2, in this embodiment, the holding module 20 is substantially rectangular and is configured for holding the work-piece 200. In other embodiments, the holding module 20 can also be other shapes to hold other shaped work-pieces. For example, the holding module 20 can be circular to hold a circle shaped work-piece. The holding module 20 includes a fixed member 21 and a movable member 22. The moveable member 22 can be movably to be coupled to the fixed member 21 to form a frame for positioning the work-piece 200. In this embodiment, the fixed member 21 is shaped as a rectangle with a corner absent. And the movable member 22 is shaped as the corner which the fixed member 21 missed.

The fixed member 21 includes a substrate 211. A connecting surface 212 is formed on the fixed member 21 for connecting the movable member 22. In this embodiment, the connecting surface 212 is formed on a corner of the substrate 211. The fixed member 21 is fixed on the faceplate 30. In this embodiment, the fixed member 21 is fixed by bolts (not shown in figures), therefore, resulting in uneven surfaces of the substrate 211.

Referring to FIG. 2, a number of fixed holes 213 are defined in the substrate 211. Each fixed hole 213 is configured for receiving an elastic ball plunger mentioned above. In this embodiment, there are four fixed holes 213. The four fixed holes 213 are spaced from each other. Each fixed holes 213 is located at a corresponding corner of the substrate 211, thereby forming a rectangle. Each fixed hole 213 can be a though hole or a blind hole. In this embodiment, each fixed hole 213 is a through hole. Each elastic member 10 can be fixed or positioned into the fixed hole 213. A normal height of the elastic member 10 is larger than a depth of the fixed hole 213. In other words, each elastic member 10 produces from a top surface of the substrate 211.

A plurality of barrier strips 214 are formed on periphery edges of the substrate 211. The barrier strips 214 are located at the edges of a top surface of the substrate 211. Each barrier strip 214 is extended from the top surface of the substrate 211 along a vertical direction away from the fixed member 21. In this embodiment, the fixed member 21 includes three barrier strips 214. And the three barrier strips 214 are formed on three corners of the fixed member 21, respectively. The barrier strips 214 have the same width and the same height. A distance between two adjacent barrier strips 214 can be designed according to actual need. In this embodiment, the three barrier strips 214 are separated from each other.

The movable member 22 can be moved under an outside force to be coupled to or be decoupled from the fixed member 21. The movable member 22 includes a base 221 and a parapet 222. A thickness of the base 221 is equal to that of the substrate 211 of the fixed member 21. A joint surface 223 is formed on a side of the base 221 to attach with the connecting surface 212 of the fixed member 21. A shape and size of the joint surface 223 are substantially matched with those of the connecting surface 212. The parapet 222 is formed at edges of a top surface of the base 221. The parapet 222 is extended from the top surface of the base 221 along a vertical direction away from the base 221. In this embodiment, the parapet 222 is shaped as a right angle. A width and a height of the parapet 222 are respectively equal to those of the barrier strip 214 of the fixed member 21.

Referring to FIG. 1 and FIG. 2, when the movable member 22 is coupled to the fixed member 21 under an outside force, the joint surface 223 of the movable member 22 is attached on the connecting surface 212 of the fixed member 21 and the parapet 222 of the movable member 22 is coupled to one of the barrier strips 214 of the fixed member 21. The base 221 of the movable member 22 cooperates with the substrate 211 of the fixed member 21 to form a rectangle bearing platform. The parapet 222 of the movable 22 and the barrier strips 214 of the fixed member 21 form a rectangle clamping space to hold the work-piece 200 therein.

The limit members are fixed on the holding module 20. In this embodiment, the limit members are illustrated as a first limit member 24 and a second limit member 25. The first limit member 24 and the second limit member 25 are located above the clamping space of the holding module 20. The first limit member 24 and the second limit member 25 are configured for limiting the work-piece 200 to move in a vertical direction.

Referring to FIG. 2, the first limit member 24 is L shaped. The first limit member 24 is fixed on one of the barrier strips 214 of the fixed member 21. Each vertical outer side of the first limit member 24 is coplanar with a corresponding outer periphery side of the barrier strip 214. A width of the first limit member 24 is larger than that of the barrier strip 214. So two inner sides of the first limit member 24 protrude from inner sides of the barrier strip 214 for limiting the work-piece 200 to move in a vertical direction.

The second limit member 25 is V shaped. The second limit member 25 is fixed on the parapet 222 of the movable member 22. The second limit member 25 and the first limit member 24 are on the cross of the holding module 20. Two outer sides of the second limit member 25 are coplanar with those of the parapet 222, respectively. A width of the second limit member 25 is equal to that of the first limit member 24. So two inner sides of the second limit member 25 produce from inner sides of the parapet 222 for limiting the work-piece 200 to move in a vertical direction.

The faceplate 30 includes a first flat 31 and a second flat 32. The second flat 32 is extended from a top surface of the first flat 31. In this embodiment, both the first flat 31 and the second flat 32 are rectangular. But a size of the second flat 32 is smaller than that of the first flat 31. Two neighboring sides of the second flat 32 are coplanar with two contiguous sides of the first flat 31, respectively. The second flat 32 is configured for carrying the fixed member 21 and bearing the movable member 22 of the holding module 20. The movable member 22 is located on one corner of the second flat 32 when the movable member 22 is jointed with the fixed member 21.

Referring to FIG. 1, in this embodiment, the movable member 22 is driven by a pump 40. The pump 40 is placed on the first flat 31. The pump 40 is connected to the movable member 22 for providing a force to drive the movable member 22.

Referring to FIG. 1 and FIG. 2, the flatness adjusting device 100 of the present disclosure can be applied in a test fixture 300. The test fixture 300 includes a test module 50. The test module 50 includes a spindly probe 51. The probe 51 extends horizontally and points to the clamping space of the holding module 20. A guide hole 215 is defined in one of the barrier strips 214 of the fixed member 21 for receiving the probe 51. The guide hole 215 is perpendicular to one side of the barrier strip 214 and penetrates therethrough. In this embodiment, the guide hole 215 is U-shaped.

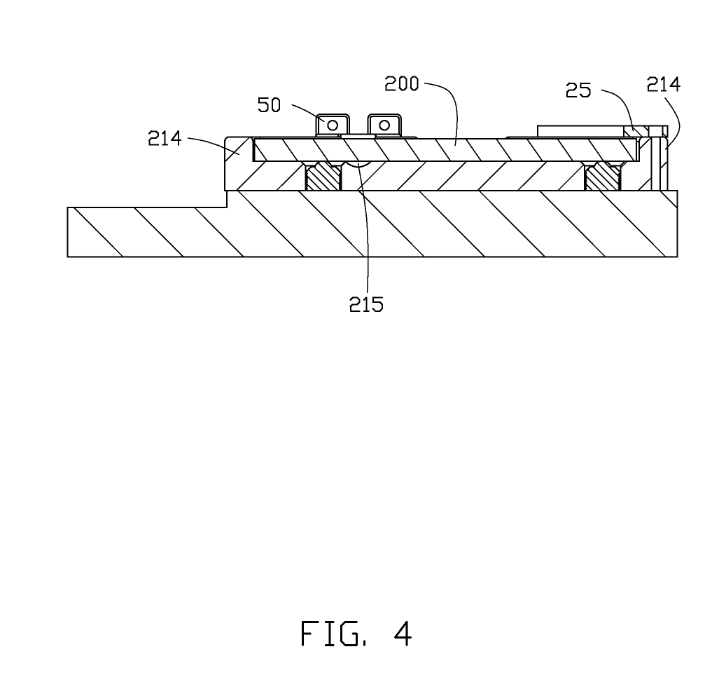

FIG. 3 and FIG. 4 show how the test fixture 300 of the present disclosure tests a wok-piece 200. The work-piece 200 is a faceplate. A shape and size of the work-piece 200 are matched with those of the clamping space of the holding module 20. The work-piece 200 includes a top surface 210, an end surface 220 and a pending test hole 230. The pending test hole 230 is recessed from the end surface 220 in a direction which is parallel to the top surface 210 and perpendicular to the end surface 220. The probe 51 of the test module 50 faces the pending test hole 230 when the test fixture 300 works.

When the test fixture 300 of the present disclosure works:

Firstly, the work-piece 200 is set on the substrate 211 of the fixed member 21. The top surface 210 of the work-piece 200 is upside and the end surface 220 of the work-piece 200 faces the guide hole 215 of the holding module 20. The elastic members 10 are located between the work-piece 200 and the substrate 211 of the fixed member 21.

Secondly, the work-piece 200 is pressed downwards to be suck under the first limit member 24. At the same time, the movable member 22 is driven by the pump 40 to connect to the fixed member 21 and the second limit member 25 abuts the work-piece 200 above.

Thirdly, the pressure for pressing the work-piece 200 downwards is removed. A gravity of the work-piece 200 and the pressure produced by the limit members deform the elastic members 10. So each elastic member 10 produce a holding power in an opposite direction of the gravity of the work-piece 200 and the pressures of the limit members. Then the work-piece 200 is propped up to bottom surfaces of the first limit member 24 and the second limit member 25 by the holding powers, thereby adjusting the top surface 210 of the work-piece 200 in a horizontal plane. The work-piece 200 is held in the clamping space of the holding module 20. The barrier strips 214 of the fixed member 21 and the parapet 222 of the movable member 22 limit the work-piece 200 to move in a horizontal direction. The elastic members 10 and the limit members limit the work-piece 200 to move in a vertical direction.

Lastly, the test module 50 is driven to insert the probe 51 though the guide hole 215 and then into the pending test hole 230 to test the work-piece 200.

Compared with the traditional test fixtures, the test fixture 300 of the present disclosure in the invention includes the flatness adjusting device 100. A bottom surface of the work-piece 200 is not located on a surface of the holding module 20, but located on the elastic members 10 of the flatness adjusting device 100. The work-piece 200 is clamped between the limit members of the holding module 20 and the elastic members 10. An elastic deformation theory of the elastic members 10 is used for adjusting relative physical surface roughness. Because the work-piece 200 is clamped under the limit members and the top surface 210 of the work-piece 200 is attached on bottom surfaces of the limit members. The work-piece 200 can be adjusted in a horizontal plane by controlling a flatness of the bottom surfaces of the limit members. Therefore, the probe 51 of the test module 50 can be horizontal and unimpeded into the pending test hole 230 of the work-piece 200.

Furthermore, not only the flatness adjusting device 100 is simple in configuration and operation, but also can the elastic members 10 of the flatness adjusting device 100 be replaced at any time without affecting the original operation of the test fixture 300.

The embodiment shown and described above is only an example. Many details are often found in the art such as the other features of a flatness adjusting device and a test fixture applying the flatness adjusting device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A flatness adjusting device, adapted for adjusting a flatness of a work-piece held therein, comprising:
a holding module configured for holding the work-piece;
a plurality of elastic members located on the holding module; and
a plurality of limit members fixed on the holding module, bottom surfaces of the limit members being level, and the bottom surfaces of the limit members and the elastic members being configured for clamping the work-piece sandwiched therebetween.

2. The flatness adjusting device of claim 1, wherein the elastic members are at least three elastic ball plungers, and the elastic ball plungers are spaced from each other to form a geometric figure, and the geometric figure is a non linear graph.

3. The flatness adjusting device of claim 1, wherein the holding module comprises a fixed member and a movable member, and the movable member is movably to be coupled to the fixed member to form a frame for positioning the work-piece.

4. The flatness adjusting device of claim 3, wherein the fixed member comprises a substrate, fixed holes and barrier strips, the fixed holes are defined in the substrate, and the barrier strips are formed on the substrate.

5. The flatness adjusting device of claim 4, wherein the fixed holes are through holes for receiving the elastic members, and each elastic member is fixed or positioned in the fixed hole.

6. The flatness adjusting device of claim 5, wherein a normal height of the elastic member is larger than a depth of the fixed hole.

7. The flatness adjusting device of claim 4, wherein each barrier strip is extended from a top surface of the substrate along a vertical direction away from the fixed member.

8. The flatness adjusting device of claim 7, wherein the barrier strips have the same width and height.

9. The flatness adjusting device of claim 4, wherein a connecting surface is formed on the fixed member, a joint surface is formed on the movable member, and the joint surface is attached on the connecting surface to couple the movable member and the fixed member.

10. The flatness adjusting device of claim 9, wherein the movable member comprises a base and a parapet formed on the base, and the joint surface is formed on a side of the base.

11. The flatness adjusting device of claim 10, wherein the parapet is formed at edges of a top surface of the base, and the parapet is extended from the top surface of the base along a vertical direction away from the base.

12. The flatness adjusting device of claim 11, wherein a thickness of the base is equal to that of the substrate of the fixed member, and a width and a height of the parapet are respectively equal to those of the barrier strip of the fixed member.

13. The flatness adjusting device of claim 12, wherein the limit members comprise a first limit member fixed on the parapet of the movable member and a second limit member fixed on one of the barrier strips of the fixed member.

14. The flatness adjusting device of claim 13, wherein a width of the first limit member is larger than that of the parapet and a width of the second limit member is larger than that of the barrier strip.

15. A test fixture comprising:
a test module for testing a work-piece;
a probe positioned horizontally and pointing to the work-piece; and
a flatness adjusting device comprising:
a holding module configured for holding the work-piece;
a plurality of elastic members located on the holding module; and
a plurality of limit members fixed on the holding module, bottom surfaces of the limit members being level, and the bottom surfaces of the limit members and the elastic members being configured for clamping the work-piece sandwiched therebetween.

16. The test fixture of claim 15, wherein the elastic members are at least three elastic ball plungers, and the elastic ball plungers are spaced from each other to form a geometric figure, the geometric figure is a non linear graph.

17. The test fixture of claim 16, wherein the holding module comprises a fixed member and a movable member, the movable member is movably to be coupled to the fixed member to form a frame for positioning the work-piece, a connecting surface is formed on the fixed member, a joint surface is formed on the movable member, and the joint surface is attached on the connecting surface to couple the movable member and the fixed member.

18. The test fixture of claim 17, wherein the fixed member comprises a substrate, fixed holes and barrier strips, the fixed holes are defined in the substrate for receiving the elastic members, each elastic member can be fixed or positioned into the fixed hole, a normal height of the elastic member is larger than a depth of the fixed hole, the barrier strips are formed on the substrate, the barrier strips have the same width and height.

19. The test fixture of claim 18, wherein the movable member comprises a base and a parapet formed on the base, the parapet is formed at edges of a top surface of the base, a thickness of the base is equal to that of the substrate of the fixed member, a width and a height of the parapet are respectively equal to those of the barrier strip of the fixed member.

20. The test fixture of claim 19, wherein the limit members comprise a first limit member fixed on the movable member and a second limit member fixed on one of the barrier strips of the fixed member, a width of the first limit member is larger than that of the parapet and a width of the second limit member is larger than that of the barrier strip.
